(19) United States
(12) Patent Application Publication
(10) Pub. No.: US 2013/0293508 A1
(43) Pub. Date: Nov. 7, 2013

(54) TOUCH PANEL, TOUCH DISPLAY PANEL AND TOUCH DISPLAY APPARATUS

(71) Applicants: Cheng-Hsing Lin, Tainan City (TW); Wei-Hung Kuo, Hsinchu County (TW); Shih-Po Chou, New Taipei City (TW); Yen-Heng Huang, New Taipei City (TW)

(72) Inventors: Cheng-Hsing Lin, Tainan City (TW); Wei-Hung Kuo, Hsinchu County (TW); Shih-Po Chou, New Taipei City (TW); Yen-Heng Huang, New Taipei City (TW)

(73) Assignee: AU OPTRONICS CORPORATION, Hsinchu (TW)

(21) Appl. No.: 13/600,245

(22) Filed: Aug. 31, 2012

(30) Foreign Application Priority Data
May 7, 2012 (TW) 101116213

(51) Int. Cl. G06F 3/044; G06F 3/041

(52) U.S. Cl. 345/174; 345/173

(57) ABSTRACT

A touch panel capable of assembling to a casing assembly having a conductive protrusion is provided. The touch panel includes a substrate, a decoration pattern layer, a touch sensing device, a reflective protecting electrode, an electrostatic discharge protecting device, a plurality of signal connecting lines, an insulating layer and a protection layer. The decoration pattern layer is located in a periphery region of the substrate and overlapped with the reflective protecting electrode. The electrostatic discharge protecting device is connected to the touch sensing device and the reflective protecting electrode to transmit electrostatic charges to the reflective protecting electrode. The signal connecting lines are overlapped with the decoration pattern layer and electrically connected to the touch sensing device. The protection layer has an opening to expose a portion of the reflective protecting electrode such that the reflective protecting electrode is electrically connected to the conductive protrusion through the opening.

### CROSS-REFERENCE TO RELATED APPLICATION

This application claims the priority benefit of Taiwan application serial no. 101116213, filed on May 7, 2012. The entirety of the above-mentioned patent application is hereby incorporated by reference herein and made a part of this specification.

### BACKGROUND OF THE DISCLOSURE

1. Field of the Disclosure

The present invention generally relates to a touch panel, and more particularly, to a touch panel of a touch display apparatus.

2. Description of Related Art

In recent years touch sensing technologies have been widely applied to all sorts of multi-media electronic products, especially the portable mobile products, for example mobile phones, electronic books (E-books), tablet PC or the like. The touch sensing technologies are used as inputting means and tend to replace conventional input devices such as keyboards and mice. This touch inputting technology not only enhances the convenience, but also becomes a popularized human-machine interface and multi-media interactions due to the intuitive operation.

In general, during the manufacturing process of the touch panel, a guard ring is fabricated in the periphery region of the touch panel and the guard ring is disposed in the outside of the signal connecting lines. The guard ring is often a ground metal circuit having a relatively large line width, thus the guard ring can effectively reduce the external noise which affects the internal electronic signal of the touch panel. In addition, an electrostatic discharge protecting device is often disposed in the touch panel so as to effectively reduce the electrostatic discharge.

However, the guard ring may take up a large area of the decoration region, thus the decoration frame of the touch panel cannot be narrowed down due to the fabricating of guard ring. On the other hand, if the touch panel is without the guard ring, the electrostatic discharge protecting device cannot be disposed in the narrowed decoration frame for reducing electrostatic discharge. Additionally, how to rapidly conduct the mass electrostatic discharge accumulated on the guard ring for preventing the touch panel from damaged becomes an important issue. Accordingly, how to fabricate a touch panel having a narrow decoration frame, electrostatic protecting function and capability of rapidly conducting electrostatic discharge becomes one of the issues to be resolved by people having ordinary skill in the art.

### SUMMARY OF THE DISCLOSURE

The invention provides a touch panel, a touch display panel and a touch display apparatus having a slim border design and favorable capability of electrostatic discharge (ESD) protection so as to rapidly conduct electrostatic discharge from the touch panel.

The present invention provides a touch panel capable of assembling to a casing assembly and the casing assembly has at least one conductive protrusion. The touch panel includes a substrate, a decoration pattern layer, a touch sensing device, a reflective protecting electrode, an electrostatic discharge protecting device, a plurality of signal connecting lines, an insulating layer and a protection layer. The substrate has a touch region and a periphery region, and the periphery region surrounds the touch region. The decoration pattern layer is located in the periphery region of the substrate. The touch sensing device is located in the touch region of the substrate. The reflective protecting electrode is located in the periphery region of the substrate and overlapped with the decoration pattern layer. The electrostatic discharge protecting device is located on the substrate. The electrostatic discharge protecting device is connected to the touch sensing device and the reflective protecting electrode so as to transmit electrostatic charges of the touch sensing device to the reflective protecting electrode. The signal connecting lines are located in the periphery region of the substrate and overlapped with the decoration pattern layer. The signal connecting lines are electrically connected to the touch sensing device. The insulating layer is disposed between the reflective protecting electrode and the signal connecting lines so that the reflective protecting electrode is electrically isolated from the signal connecting lines. The protection layer covers the touch sensing device, the electrostatic discharge protecting device, the signal connecting lines, the reflective protecting electrode and the decoration pattern layer, wherein the protection layer has at least one opening to expose a portion of the reflective protecting electrode. The reflective protecting electrode is electrically connected to the conductive protrusion of the casing assembly via the opening.

The present invention further provides a touch display panel capable of assembling to a casing assembly, and the casing assembly has at least one conductive protrusion. The touch display panel includes a display panel and a touch panel. The display panel has a light emitting side. The touch panel is disposed on the light emitting side of the display panel and assembled to the display panel, wherein the touch panel includes a substrate, a decoration pattern layer, a touch sensing device, a reflective protecting electrode, an electrostatic discharge protecting device, a plurality of signal connecting lines, an insulating layer and a protection layer. The substrate has a touch region and a periphery region, and the periphery region surrounds the touch region. The decoration pattern layer is located in the periphery region of the substrate. The touch sensing device is located in the touch region of the substrate. The reflective protecting electrode is located in the periphery region of the substrate and overlapped with the decoration pattern layer. The electrostatic discharge protecting device is located on the substrate. The electrostatic discharge protecting device is connected to the touch sensing device and the reflective protecting electrode so as to transmit electrostatic charges of the touch sensing device to the reflective protecting electrode. The signal connecting lines are located in the periphery region of the substrate and overlapped with the decoration pattern layer. The signal connecting lines are electrically connected to the touch sensing device. The insulating layer is disposed between the reflective protecting electrode and the signal connecting lines so that the reflective protecting electrode is electrically isolated from the signal connecting lines. The protection layer covers the touch sensing device, the electrostatic discharge protecting device, the signal connecting lines, the reflective protecting electrode and the decoration pattern layer, wherein the protection layer has at least one opening to expose a portion of the reflective protecting electrode. The reflective protecting electrode is electrically connected to the conductive protrusion of the casing assembly via the opening.

The present invention further provides a touch display apparatus including a casing assembly, a display panel and a touch panel. The casing assembly has at least one conductive protrusion. The display panel has a light emitting side. The touch panel is disposed on the light emitting side of the display panel and assembled to the display panel, wherein the display panel is located between the touch panel and the casing assembly. The touch panel includes a substrate, a decoration pattern layer, a touch sensing device, a reflective protecting electrode, an electrostatic discharge protecting device, a plurality of signal connecting lines, an insulating layer and a protection layer. The substrate has a touch region and a periphery region, and the periphery region surrounds the touch region. The decoration pattern layer is located in the periphery region of the substrate. The touch sensing device is located in the touch region of the substrate. The reflective protecting electrode is located in the periphery region of the substrate and overlapped with the decoration pattern layer. The electrostatic discharge protecting device is located on the substrate. The electrostatic discharge protecting device is connected to the touch sensing device and the reflective protecting electrode so as to transmit a electrostatic charges of the touch sensing device to the reflective protecting electrode. The signal connecting lines are located in the periphery region of the substrate and overlapped with the decoration pattern layer. The signal connecting lines are electrically connected to the touch sensing device. The insulating layer is disposed between the reflective protecting electrode and the signal connecting lines so that the reflective protecting electrode is electrically isolated from the signal connecting lines. The protection layer covers the touch sensing device, the electrostatic discharge protecting device, the signal connecting lines, the reflective protecting electrode and the decoration pattern layer, wherein the protection layer has at least one opening to expose a portion of the reflective protecting electrode. The reflective protecting electrode is electrically connected to the conductive protrusion of the casing assembly via the opening.

In light of the above, since the reflective protecting electrode covers the noise of the external environment, the touch panel of the present invention does not need to dispose any guard ring. Thus, the touch panel can have a slim border design. Moreover, the electrostatic discharge protecting device is used to transmit electrostatic charges of the touch sensing device to the reflective protecting electrode, and the reflective protecting electrode is electrically connected to the conductive protrusion of the casing assembly such that the casing assembly is always in a ground state. Thus, the touch panel of the present invention has a favorable electrostatic protecting effect.

In order to make the aforementioned properties and advantages of the invention more comprehensible, embodiments accompanied with figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1A schematically shows a perspective view of a touch panel and a casing assembly according to a first embodiment of the present invention.

FIG. 1B is a partially enlarged schematic view of portion M of FIG. 1A.

FIG. 2A schematically shows a cross-sectional view of the touch panel according to the first embodiment of the present invention.

FIG. 2B schematically and partially shows a cross-sectional view of a touch panel according to another embodiment of the present invention.

FIG. 3A to FIG. 3C are schematic views illustrating a fabrication method of the touch panel according to the first embodiment of the present invention.

FIG. 4 schematically shows a cross-sectional view of a touch panel according to a second embodiment of the present invention.

FIG. 5 schematically shows a cross-sectional view of a touch panel according to a third embodiment of the present invention.

FIG. 6 schematically shows a cross-sectional view of a touch panel according to a fourth embodiment of the present invention.

FIG. 7 schematically shows a perspective view of a touch display apparatus according to one embodiment of the present invention.

FIG. 8 schematically shows a perspective view of a touch display apparatus according to another embodiment of the present invention.

FIG. 9 schematically shows a cross-sectional view of a touch display apparatus according to one embodiment of the present invention.

### DETAILED DESCRIPTION OF THE EMBODIMENTS

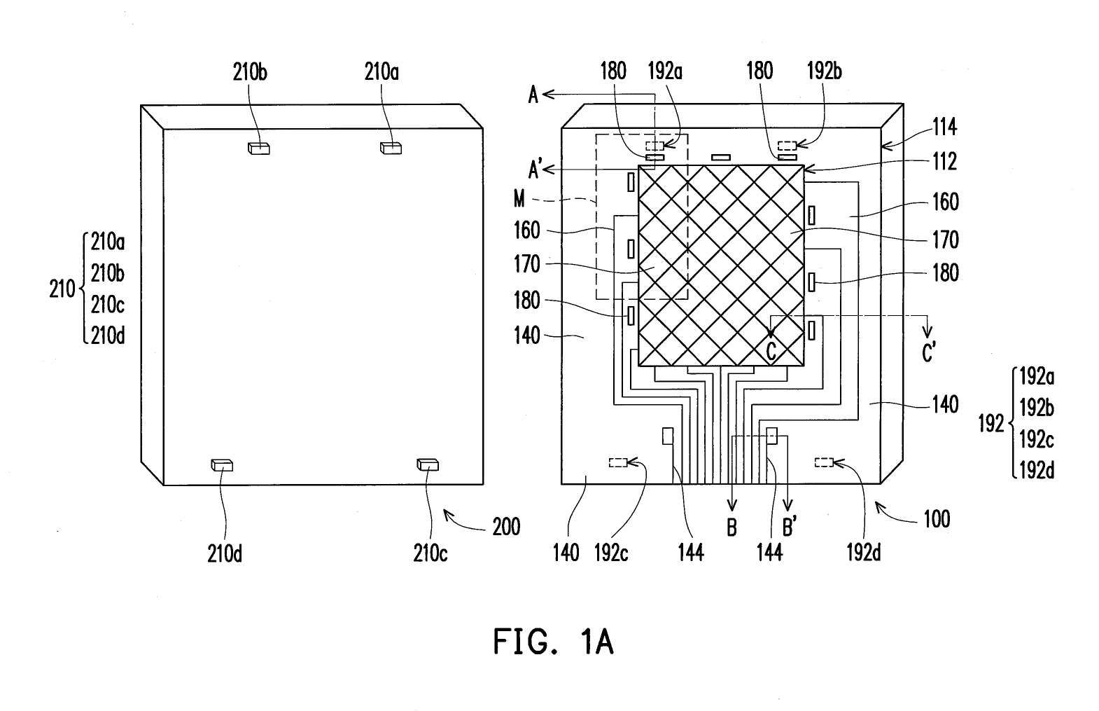

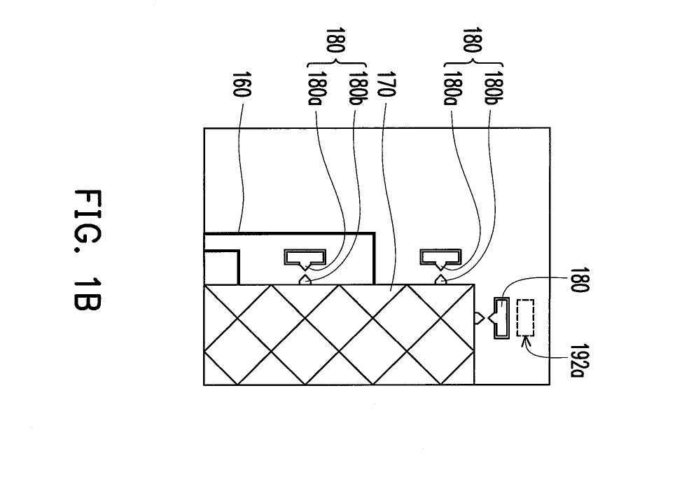

FIG. 1A schematically shows a perspective view of a touch panel and a casing assembly according to a first embodiment of the present invention, wherein some film layers are omitted in FIG. 1A. FIG. 1B is a partially enlarged schematic view of portion M of FIG. 1A. FIG. 2A schematically shows a cross-sectional view of the touch panel according to the first embodiment of the present invention. In addition, FIG. 2A is a cross-sectional view of a touch panel along sectioning lines A-A′, B-B′ and C-C′ of FIG. 1A.

Referring to FIG. 1A, FIG. 1B and FIG. 2A, the touch panel 100a of the embodiment is capable of assembling to a casing assembly 200, and the casing assembly 200 has at least one conductive protrusion 210. The touch panel 100a includes a substrate 110, a decoration pattern layer 120, a touch sensing device 170, a reflective protecting electrode 140, an electrostatic discharge protecting device 180, a plurality of signal connecting lines 160, an insulating layer 150 and a protection layer 190. Herein the material of the substrate 110 is, for example, glass, reinforced glass, quartz, sapphire, plastic, plastic mixing material, the stacked thereof or the like. The substrate 110 is preferred to be a transparent substrate, and can be a rigid substrate or a flexible substrate capable of appropriate deformation. The casing assembly 200 may be a metal casing having a conductive material or any other conductive material which is capable of conducting electrostatic charges or leading a large amount of electrostatic charges of the touch panel 100a to be conducted to the casing assembly 200 via the conductive protrusion 210.

The substrate 110 has a touch region 112 and a periphery region 114, and the periphery region 114 surrounds the touch region 112. According to the embodiment, for example, the substrate 110 is a cover substrate, and can protect internal components.

The decoration pattern layer 120 is located in the periphery region 114 of the substrate 110. The material of the decoration pattern layer 120 is, for example, an organic material, an inorganic material, a stacked layer thereof or a mixing material thereof. The organic material is resin, for example. The inorganic material is metal oxide material, for example. The decoration pattern layer 120 is often located in the periphery of the touch panel 100a, and the external appearance of the frame of the touch panel 100a depends on pattern and color of the decoration pattern layer 120. In addition, the decoration pattern layer 120 is used to cover the circuit layout located in the periphery region 114 of the substrate 110, in order to avoid users to be aware of the existence of the circuit layout during operating the touch panel 100a. In the embodiment, the decoration pattern layer 120 is, for example, a white decoration pattern layer, a light color decoration pattern layer or a black decoration pattern layer. People having ordinary skill in the art of the invention can adjust the material, pattern and color of the decoration pattern layer 120 according to requirement, and the present invention is not limited thereto.

The reflective protecting electrode 140 is located in the periphery region 114 of the substrate 110 and overlapped with the decoration pattern layer 120. Specifically, the reflective electrostatic electrode 140 may be used to reflect lights, thus users are hard to be aware of the internal circuit layout from the decoration pattern layer 120. According to the embodiment, an overlapping area of the reflective protecting electrode 140 and the decoration pattern layer 120 is greater than 50% of the total area of the decoration pattern layer 120. Thus, the reflective protecting electrode 140 can effectively reflect lights such that the touch panel 100a has an artistic appearance. If the decoration pattern layer 120 is a white decoration pattern, the extent of whiteness of the decoration pattern layer 120 can be increased so that users can feel the pattern is whiter. The material of the reflective protecting electrode 140 includes reflective conductive material, and the reflective conductive material is, for example, metal or stacked layer of the reflective layer and the conductive layer, wherein the metal may be aluminum, silver, copper, gold, nickel, chromium, molybdenum, titanium, zinc or the like. The reflective layer may be a multi-layered reflective film capable of increasing the reflective effect of the decoration pattern layer 120 so that the color of the decoration pattern layer 120 can be brighter.

According to the embodiment, a planar layer 130 may be selectively disposed in the touch panel 100a. The planar layer 130 is located between the decoration pattern layer 120 and the reflective protecting electrode 140. The planar layer 130 may provide a planar interface which is advantageous to the follow-up film layer fabrication. However, the invention is not limited thereto. In other embodiments not shown in figures, the touch panel 100a may be without the planar layer 130 and the reflective protecting electrode 140 is directly disposed on the decoration pattern layer 120.

The insulating layer 150 is disposed on the reflective protecting electrode 140. The signal connecting lines 160 are located in the periphery region 114 of the substrate 110 and overlapped with the decoration pattern layer 120. Specifically, the insulating layer 150 is disposed between the reflective protecting electrode 140 and the signal connecting lines 160 so that the reflective protecting electrode 140 is electrically isolated from the signal connecting lines 160. The material of the insulating layer 150 may be an organic insulating material or an inorganic insulating material. The organic insulating material can be polyimide (PI) or the like. The inorganic insulating material can be silicon oxide, silicon nitride, silicon nitride oxide, or the like, and the present invention is not limited thereto.

Moreover, in another embodiment, the touch panel 100a may include at least one protecting connecting line 144 electrically connected to the reflective protecting electrode 140. The protecting connecting line 144 is located in the periphery region 114 of the substrate 110 and arranged in order with the signal connecting lines 160. Accordingly, the protecting connecting line 144 may be connected to the flexible printed circuit (FPC) board (not shown), and via the FPC board the protecting connecting line 144 may transmit electrostatic charges to the circuit board or integrated circuit for spreading electrostatic charges.

As illustrated above, the protecting connecting line 144 may be connected to the circuit board, for example, and since the circuit board is in a ground state the reflective protecting electrode 140 may have a grounded potential. Since the reflective protecting electrode 140 is located in the periphery region 114 of the substrate 110 and having a grounded potential, the reflective protecting electrode 140 has the efficacy of covering the noise of the external environment. Therefore, the touch panel 100a of the embodiment does not need to dispose a guard ring, i.e., the existing reflective protecting electrode 140 can be used to obtain the covering and protecting performance. Accordingly, since disposing of the guard ring is unnecessary, the touch panel 100a may be narrowed down to have a slim border design.

The touch sensing device 170 is located in the touch region 112 of the substrate 110 and electrically connected to the signal connecting lines 160. According to the embodiment, the touch sensing device 170 is, for example, a capacitance touch sensing device, and the capacitance touch sensing device is, for example, a projected capacitance sensing device or a surface capacitance sensing device. In the embodiment, take the projected capacitance sensing device as an example, the touch sensing device 170 is composed of first sensing series and second sensing series alternatively arranged to each other, wherein the first sensing series and the second sensing series are series formed by the connection of sensing pads 176 and bridge lines 172, 174, for example. When the touch panel 100a senses the touch event, the touch sensing device 170 may transmit a signal of the touch sensing device 170 to the signal connecting lines 160 and then transmits the signal to the back-end circuit processing unit. The detailed descriptions of the projected capacitance sensing device or the surface capacitance sensing device are well known to one ordinary skilled in the art, and thus no further description is provided herein.

The electrostatic discharge protecting device 180 is located on the substrate 110 and may be located between the touch sensing device 170 and the reflective protecting electrode 140. The electrostatic discharge protecting device 180 is electrically connected to the reflective protecting electrode 140, and the electrostatic discharge protecting device 180 is electrically connected to the electrically connected to the touch sensing device 170. According to the embodiment, take the electrostatic discharge protecting device 180 being a tip electrostatic discharge device as an example, the electrostatic discharge protecting device 180 has a first tip 180a, for example, and a second tip 180b is disposed at the edge of the touch sensing device 170. The first tip 180a of the electrostatic discharge protecting device 180 is adjacent to, but not contact with the second tip 180b, and the first tip 180a and the second tip 180b may be located on the same plane (as shown in FIG. 1B), and may be oppositely disposed and separated by the insulating layer 150. When a large amount of electrostatic charges exists in the touch sensing device 170, the electrostatic charges can be transmitted from the touch sensing device 170 to the electrostatic discharge protecting device 180 by means of point discharging method. Then the electrostatic discharge protecting device 180 may transmit the electrostatic charges to the reflective protecting electrode 140 having a grounded potential. Thus, the electrostatic charges may not be accumulated too much in the touch sensing device 170 and electrostatic discharge may not occur, so that the touch sensing device 170 can be prevented from causing damage.

As mentioned above, the electrostatic discharge protecting device 180 can reduce the damage of touch sensing device 170 or other internal components of the touch panel 100a due to electrostatic discharge. In this embodiment, the electrostatic discharge protecting device 180 can be a tip electrostatic discharge device, which should however not be construed as a limitation to this invention. In other embodiments, the electrostatic discharge protecting device 180 may be a diode electrostatic discharge device, a transistor electrostatic discharge device or a floating gate transistor electrostatic discharge device, which should however not be construed as a limitation to this invention.

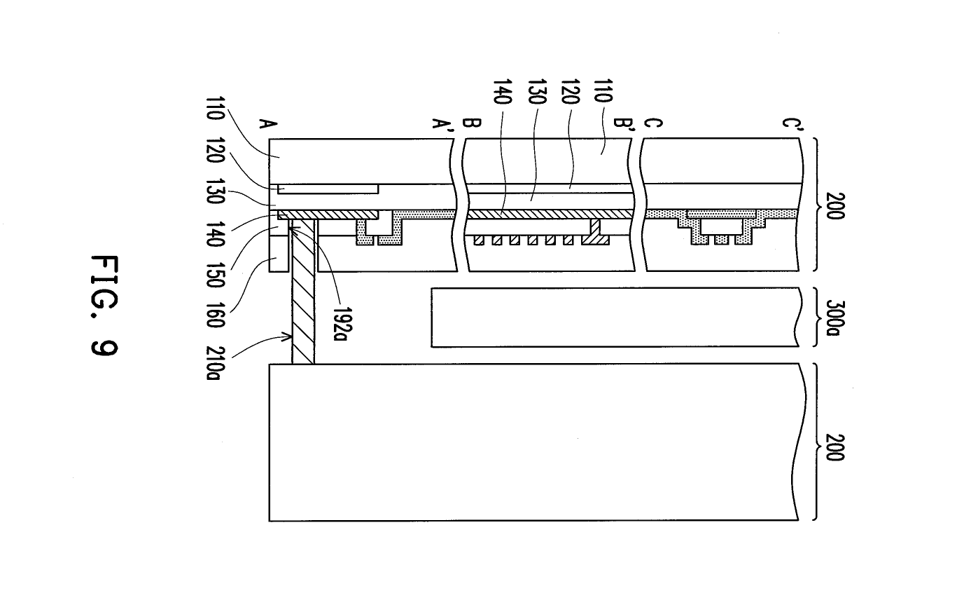

The protection layer 190 covers the touch sensing device 170, the electrostatic discharge protecting device 180, the signal connecting lines 160, the reflective protecting electrode 140 and the decoration pattern layer 120. The protection layer 190 has at least one opening 192. The opening 192 exposes a portion of the reflective protecting electrode 140. In the embodiment, the insulating layer 150 may further include a through hole 152, wherein the through hole 152 is communicated with the opening 192 of the protection layer 190 so as to expose a portion of the reflective protecting electrode 140. Therefore, as shown in FIG. 9, when the touch panel 100a and the casing assembly 200 is assembled together, the reflective protecting electrode 140 may be electrically connected to the conductive protrusion 210 of the casing assembly 200 via the opening 192.

In other embodiments, as shown in FIG. 2B, the touch panel 100a may further include a protecting contacting pad 142. The protecting contacting pad 142 is located in the opening 192 and electrically connected to the reflective protecting electrode 140, and the protecting contacting pad 142 is simultaneously fabricated with the electrostatic discharge protecting device 180, for example. The reflective protecting electrode 140 may be electrically connected to the conductive protrusion 210 via the protecting contacting pad 142.

Referring to FIG. 1A, FIG. 1B and FIG. 2A, when the casing assembly 200 and the touch panel 100a are assembled together, the conductive protrusion 210a, the conductive protrusion 210b, the conductive protrusion 210c and the conductive protrusion 210d are electrically connected to the reflective protecting electrode 140 via the opening 192a, the opening 192b, the opening 192c and the opening 192d, respectively. In other words, the conductive protrusion 210 and the opening 190 are correspondingly disposed, so that the conductive protrusion 210 and the reflective protecting electrode 140 are electrically connected.

As illustrated above, when the electrostatic charges of the touch sensing device 170 is transmitted to the reflective protecting electrode 140 via the electrostatic discharge protecting device 180, the electrostatic charges can be further transmitted to the casing assembly 200 via the conductive protrusion 210. Accordingly, after the touch panel 100a and the casing assembly 200 are assembled together, the touch panel 100a may have a better electrostatic protection performance.

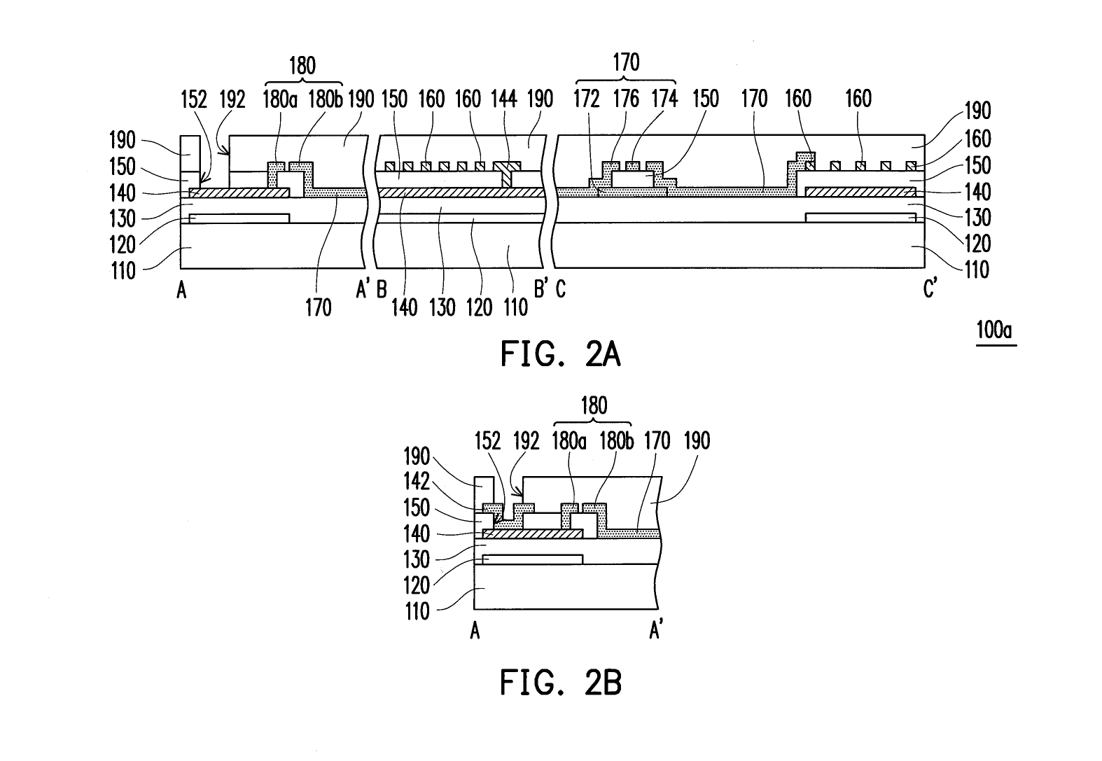

FIG. 3A to FIG. 3C are schematic views illustrating a fabrication method of the touch panel according to the first embodiment of the present invention. Referring to both FIG. 1A and FIG. 3A, after the decoration pattern layer 120 is fabricated in the periphery region 114 of the substrate 110, the planar layer 130 may be selectively formed on the decoration pattern layer 120. Then the reflective protecting electrode 140 is formed on the planar layer 130, wherein the reflective protecting electrode 140 is overlapped with the decoration pattern layer 120.

Referring to FIG. 1A and FIG. 3B, the bridge line 172 of the touch sensing device 170 may be fabricated on the planar layer 130, wherein the bridge line 172 may be independently fabricated by using a transparent conductive material, for example. In another embodiment, the bridge line 172 may also be formed with the reflective protecting electrode 140 in the same step of fabricating process, but it is favorable that the bridge lien 172 is formed with the decoration pattern layer 120 in the same step of fabricating process (not shown) after a pattern layer is formed beneath. Then, the insulating layer 150 is formed. The insulating layer 150 covers the reflective protecting electrode 140 and the bridge line 172. After that the insulating layer 150 is patterned, and the patterned insulating layer 150 may include a plurality of through holes 152, wherein the through holes 152 expose a portion of the reflective protecting electrode 140. Then, the signal connecting lines 160 are formed on the insulating layer 150, and the protecting contacting line 144 is selectively formed, wherein the protecting contacting line 144 is electrically connected to the reflective protecting electrode 140 via some of the through holes 152.

Referring to FIG. 1A and FIG. 3C, the touch sensing device 170 and the electrostatic discharge protecting device 180 are fabricated on the substrate 110, wherein the electrostatic discharge protecting device 180 is electrically connected to the reflective protecting electrode 140 via some of the through holes 152. Accordingly, the electrostatic charges of the touch sensing device 170 may be transmitted to the reflective protecting electrode 140 via the electrostatic discharge protecting device 180 and electrostatic discharge is hard to occur, thus the process yield can be improved. In this embodiment, the electrostatic discharge protecting device 180 is simultaneously fabricated with the touch sensing device 170 and is the same material as the touch sensing device 170, for example. However, the invention is not limited thereto. In this embodiment, the electrostatic discharge protecting device 180 may also be simultaneously fabricated with the reflective protecting electrode 140 and is the same material as the reflective protecting electrode 140, for example. Of course, the electrostatic discharge protecting device 180 may also be independently fabricated with the touch sensing device 170 and is the different material with the touch sensing device 170, for example.

Then, the protection layer 190 is formed on the substrate 110 to cover the touch sensing device 170, the electrostatic discharge protecting device 180, the signal connecting lines 160, the reflective protecting electrode 140 and the decoration pattern layer 120. Next, the protection layer 190 is patterned so as to form the at least one opening 192. The opening 192 is communicated with one of the through holes 152 of the insulating layer 150 in order to expose the reflective protecting electrode 140, for example. Thus, the conductive protrusion 210 of the casing assembly 200 may be electrically connected to the reflective protecting electrode 140 via the opening 192.

Thereby, the formation of the touch panel 100a is completed. Referring to FIG. 3C, the reflective protecting electrode 140 is located on the decoration pattern layer 120, and the insulating layer 150 covers the reflective protecting electrode 140. The signal connecting lines 160 are located on the insulating layer 150, and the protection layer 190 covers the signal connecting lines 160 and the insulating layer 150.

Other alternative embodiments are illustrated as follows. It should be mentioned that the reference numbers and some of the descriptions in the previous embodiment are applicable in the following embodiments. Identical or similar components in the previous and following embodiments are denoted by identical reference numbers, and the same descriptions in the previous and following embodiments are not reiterated herein. Specifically, these identical or similar components can be learned from the explanation in the previous embodiment, and thus no other description is provided below.

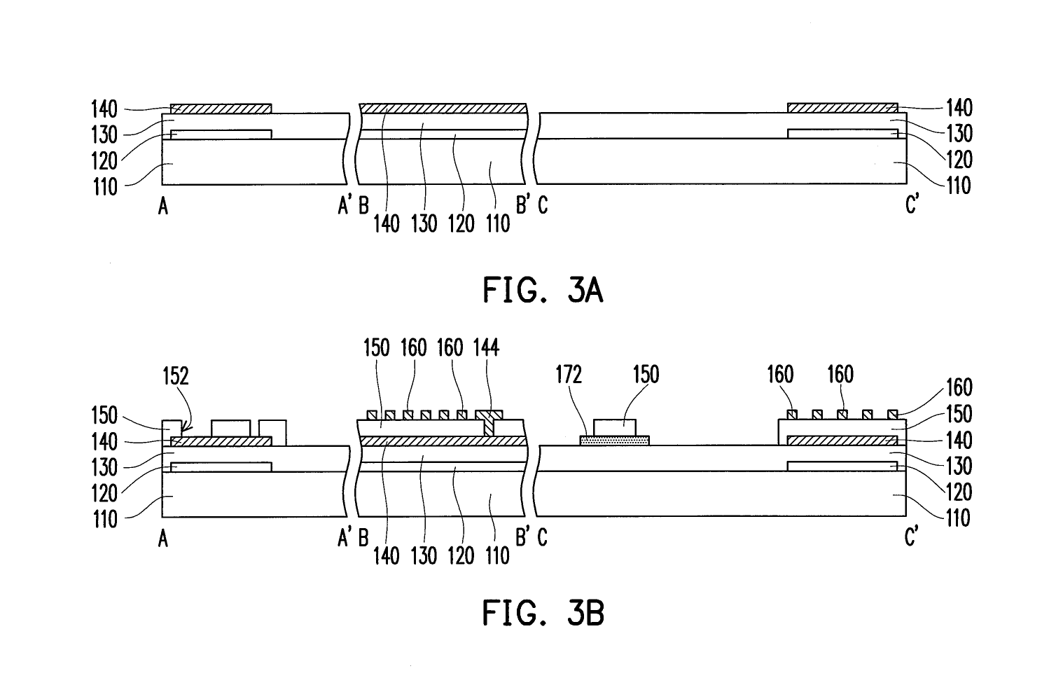

FIG. 4 schematically shows a cross-sectional view of a touch panel according to a second embodiment of the present invention. In the second embodiment of the present invention, the touch panel 100b may include an auxiliary protecting electrode 146 electrically connected to the reflective protecting electrode 140. Referring to FIG. 4, as for the touch panel 100b, the signal connecting lines 160 and the auxiliary protecting electrode 146 are fabricated first, and then the touch sensing device 170 and the electrostatic discharge protecting device 180 are fabricated. Next, the insulating layer 150 is formed and the reflective protecting electrode 140 is fabricated on the insulating layer 150. The auxiliary protecting electrode 146 is located in the periphery region 114 of the substrate 110 and may be arranged in order with the signal connecting lines 160 in order to assist in spreading electrostatic charges.

As illustrated above, the signal connecting lines 160 are formed after the reflective protecting electrode 140 is fabricated in the touch panel 100a of the first embodiment, whereas in the touch panel 100b of the present embodiment the reflective protecting electrode 140 is fabricated after the signal connecting lines 160 are formed. Specifically, in the embodiment, the signal connecting lines 160 are located on the decoration pattern layer 120, and the insulating layer 150 covers the signal connecting lines 160. The reflective protecting electrode 140 is located on the insulating layer 150, and the protection layer 190 covers the reflective protecting electrode 140 and the insulating layer 150.

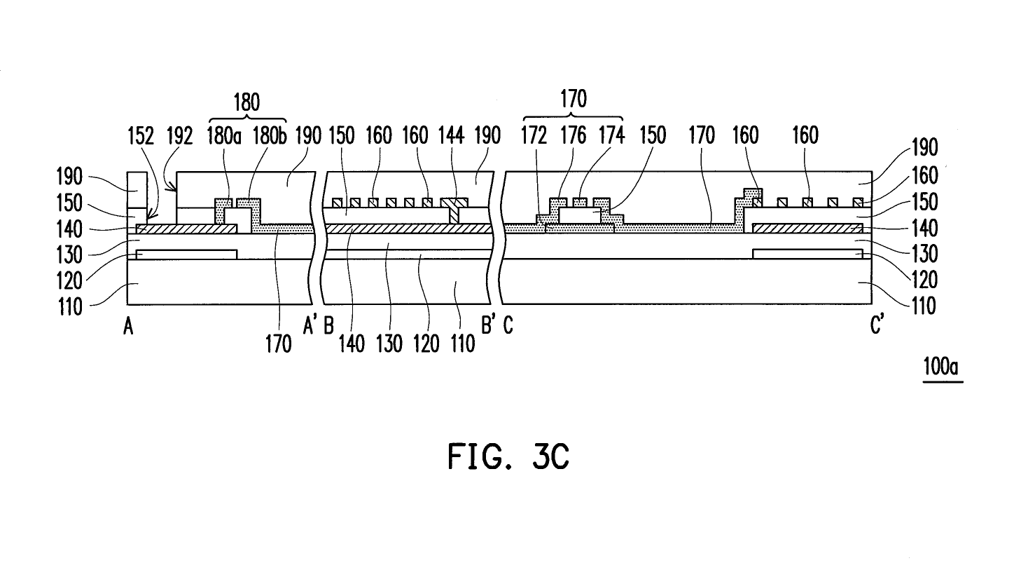

FIG. 5 schematically shows a cross-sectional view of a touch panel according to a third embodiment of the present invention. Referring to FIG. 5, the touch panel 100c of the present embodiment is substantially similar in structure to the touch panel 100a of the first embodiment, and the difference is described in the following.

Referring to FIG. 5, the fabricating process of the touch panel 100c may further include forming a plurality of auxiliary signal connecting lines 166. In this embodiment, the auxiliary signal connecting lines 166 may be simultaneously fabricated with the reflective protecting electrode 140 and may be the same material as the reflective protecting electrode 140, for example. However, the invention is not limited thereto. In other embodiments, the auxiliary signal connecting lines 166 and the reflective protecting electrode 140 may be separately fabricated, and may be different material with the reflective protecting electrode 140, for example. Specifically, the auxiliary signal connecting lines 166 and the reflective protecting electrode 140 are located on the same layer and electrically connected to the touch sensing device 170.

In the embodiment, the signal connecting lines 160 and the auxiliary signal connecting lines 166 may be electrically connected to the touch sensing device 170 and transmit the touch sensing signal to the back-end circuit processing unit. Accordingly, the touch sensing device 170 may transmit signals via the signal connecting lines 160 and the auxiliary signal connecting lines 166 which are located in different layers. The signal connecting lines 160 and the auxiliary signal connecting lines 166 are preferable to be alternatively arranged to each other so as to reduce the overlapped gap therebetween. Therefore, the quantity of signal connecting lines 160 originally disposed on the same layer can be reduced, so that the width of the decoration frame can further be narrowed down without affecting the users' feeling of the external appearance of the product.

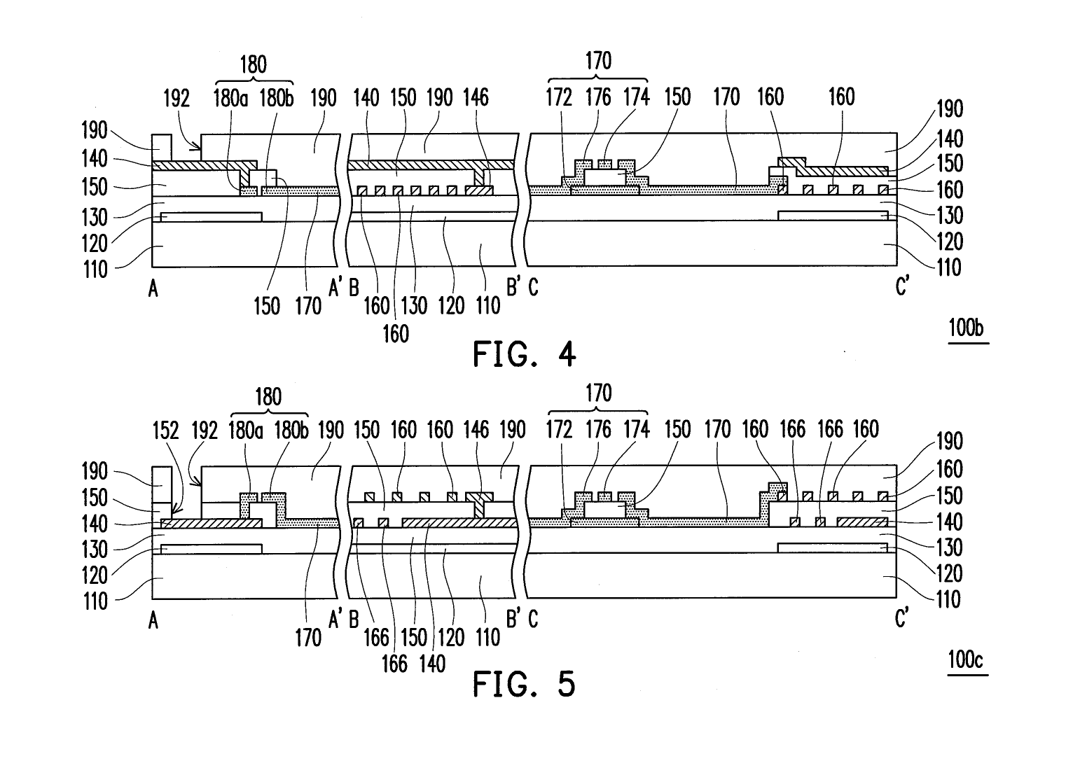

FIG. 6 schematically shows a cross-sectional view of a touch panel according to a fourth embodiment of the present invention. Referring to FIG. 6, the touch panel 100d of the present embodiment is substantially similar in structure to the touch panel 100ca of the third embodiment, and the difference is described in the following.

Referring to FIG. 6, the difference between the touch panel 100c and the touch panel 100d is that, the reflective protecting electrode 140 is fabricated after the signal connecting lines 160 are formed in the touch panel 100d of the embodiment. Specifically, the touch panel 100d also includes a plurality of auxiliary signal connecting lines 166. The auxiliary signal connecting lines 166 and the reflective protecting electrode 140 are located on the same layer and electrically connected to the touch sensing device 170, for example. Moreover, the auxiliary signal connecting lines 166 are also adapted to transmit the touch sensing signals to the back-end circuit processing unit. Accordingly, the touch sensing device 170 may transmit signals via the signal connecting lines 160 and the auxiliary signal connecting lines 166 which are located in different layers. Thus, the quantity of the signal connecting lines 160 formed on the same layer may be reduced, so that the width of the decoration frame can further be narrowed down.

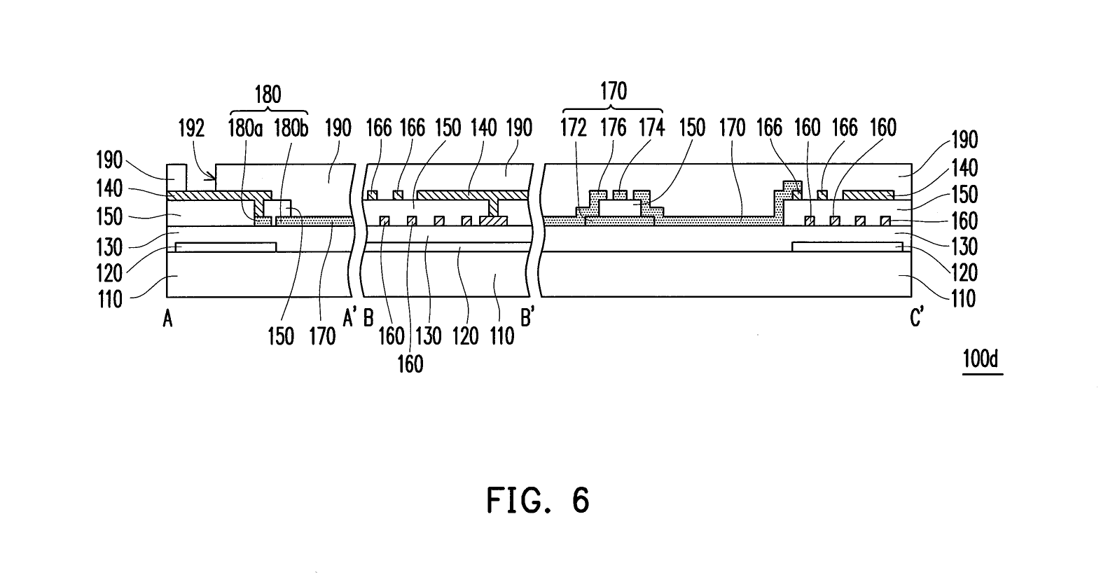

FIG. 7 schematically shows a perspective view of a touch display apparatus according to one embodiment of the present invention. Referring to FIG. 7, the touch display apparatus 2000a includes a casing assembly 200 and a touch display panel 1000a, wherein the touch display panel 1000a may be assembled to the casing assembly 200. Herein the structure of the casing assembly 200 is as shown in FIG. 1A, for example. The casing assembly 200 in this embodiment has at least one conductive protrusion 210. Herein, for example, the conductive protrusion 210a corresponds to the opening 192a and electrically connected to the reflective protecting electrode via the opening 192a, and the other parts are the same.

The touch display panel 1000a includes a display panel 300a and a touch panel 100, wherein the touch panel 100 may be, for example, the touch panel 100a, the touch panel 100b, the touch panel 100c or the touch panel 100d. However, the present invention is not limited thereto. The display panel 300a has a light emitting side 300S. The touch panel 100 is disposed on the light emitting side 300S of the display panel 300a and assembled to the display panel 300a.

In the embodiment, the display panel 300a can be a liquid crystal display panel, an organic light emitting diode display panel, an electrophoresis display panel, a field emission display panel, a plasma display panel or the like.

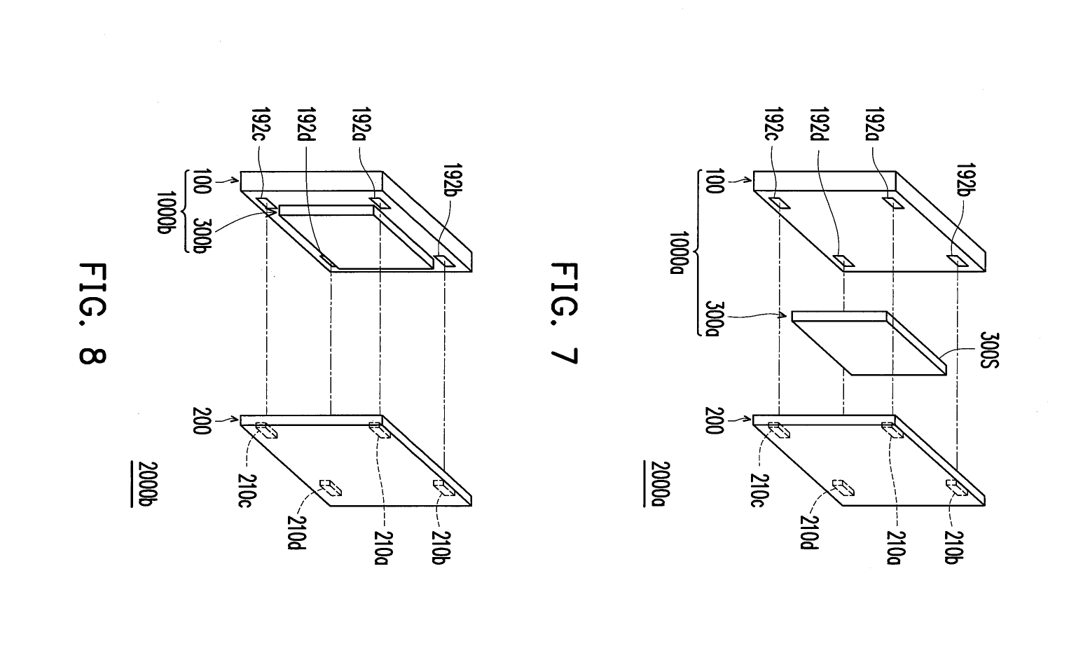

In the embodiment, the display panel 300a may be, for example, a finished product of display panel including an upper substrate and a lower substrate, wherein the upper substrate may be an active device array substrate and the lower substrate may be an opposite substrate or a cover substrate. However, the invention is not limited thereto. FIG. 8 schematically shows a perspective view of a touch display apparatus according to another embodiment of the present invention. Referring to FIG. 8, in the touch display apparatus 2000b of the present embodiment, the display panel 300b may be, for example, a semi-finished product of display panel. For instance, the opposite substrate of the display panel may be integrally fabricated with the touch panel 100. In other words, each of the components of the opposite substrate may be directly fabricated on the touch panel 100 in order to omit the use of a substrate. Therefore, the semi-finished product of the display panel is referred to the lower substrate.

For instance, if the display panel 300b is a semi-finished product of the liquid crystal display panel, the display panel 300b is, for example, a lower substrate having an active device array and a pixel array disposed thereon, and color pattern layer and the common electrode layer are disposed on the touch panel 100. If the display panel 300b is a semi-finished product of an organic light emitting diode display panel, the display panel 300b is, for example, a lower substrate having a cathode, a light emitting material layer and an anode disposed thereon. If the display panel 300b is a semi-finished product of an electrophoresis display panel, the display panel 300b is, for example, a lower substrate having a conductive layer, an electrophoresis display media and an active device array layer disposed thereon. If the display panel 300b is a semi-finished product of a field emission display panel, the display panel 300b is, for example, a lower substrate having an electron emitting device disposed thereon, and the electrode layer and the light emitting material layer are disposed on the touch panel. If the display panel 300b is a semi-finished product of a plasma display panel, the display panel 300b is, for example, a lower substrate having a positioning electrode and a color pattern layer disposed thereon.

Accordingly, as described above, the touch display apparatus 1000a and the touch display apparatus 1000b include the touch panel 100, and the touch panel 100 may be, as aforementioned illustration, the touch panel 100a, the touch panel 100b, the touch panel 100c or the touch panel 100d. Thus, the touch display apparatus 1000a and the touch display apparatus 1000b of the embodiment can have narrowed down decoration frame design and superior electrostatic protection effect.

In light of the foregoing, in the touch panel of the present invention, the reflective protecting electrode may be electrically connected to the electrostatic discharge protecting device via the through hole of the insulating layer. And the reflective protecting electrode may be, for example, electrically connected to the circuit board to have a grounded potential through the auxiliary protecting electrode and the protecting connecting line. Accordingly, the reflective protecting electrode not only can have the reflective light to beautify the external appearance of the decoration pattern layer, but also can obtain the efficacy of covering the noise of the external environment.

Moreover, the electrostatic discharge protecting device is electrically connected to the reflective protecting electrode in the present invention, and the reflective protecting electrode is electrically connected to the conductive protrusion of the casing assembly. When electrostatic charges occurs in the touch sensing device, the electrostatic discharge protecting device may transmit the electrostatic charges to the casing assembly which is in a ground state. Thus, the touch panel of the present invention is hard to be damaged due to the electrostatic discharge and has a favorable electrostatic protecting effect.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A touch panel capable of assembling to a casing assembly, the casing assembly having at least one conductive protrusion, the touch panel comprising:
a substrate having a touch region and a periphery region, the periphery region surrounding the touch region;
a decoration pattern layer located in the periphery region of the substrate;
a touch sensing device located in the touch region of the substrate;
a reflective protecting electrode located in the periphery region of the substrate and overlapped with the decoration pattern layer;
an electrostatic discharge protecting device located on the substrate, wherein the electrostatic discharge protecting device is connected to the touch sensing device and the reflective protecting electrode so as to transmit electrostatic charges of the touch sensing device to the reflective protecting electrode;
a plurality of signal connecting lines located in the periphery region of the substrate and overlapped with the decoration pattern layer, wherein the signal connecting lines are electrically connected to the touch sensing device;
an insulating layer disposed between the reflective protecting electrode and the signal connecting lines so that the reflective protecting electrode is electrically isolated from the signal connecting lines; and
a protection layer covering the touch sensing device, the electrostatic discharge protecting device, the signal connecting lines, the reflective protecting electrode and the decoration pattern layer, wherein the protection layer has at least one opening to expose a portion of the reflective protecting electrode such that the reflective protecting electrode is electrically connected to the conductive protrusion of the casing assembly through the opening.

2. The touch panel as claimed in claim 1, wherein the decoration pattern layer comprises a white decoration pattern layer, a light color decoration pattern layer or a black decoration pattern layer.

3. The touch panel as recited in claim 1, wherein a material of the decoration pattern layer comprises an organic material or an inorganic material.

4. The touch panel as claimed in claim 1, further comprising a planar layer, wherein the planar layer is located between the touch sensing device and the substrate, and located between the decoration pattern layer and the reflective protecting electrode.

5. The touch panel as claimed in claim 1, wherein a material of the reflective protecting electrode comprises a reflective conductive material.

6. The touch panel as claimed in claim 5, wherein a material of the reflective protecting electrode comprises a metal or a stacked layer including a reflective layer and a conductive layer.

7. The touch panel as claimed in claim 1, wherein an overlapping area of the reflective protecting electrode and the decoration pattern layer is greater than 50% of a total area of the decoration pattern layer.

8. The touch panel as claimed in claim 1, wherein the electrostatic discharge protecting device comprises a tip electrostatic discharge device, a diode electrostatic discharge device, a transistor electrostatic discharge device or a floating gate transistor electrostatic discharge device.

9. The touch panel as claimed in claim 8, wherein the tip electrostatic discharge device comprises a first tip connected to the touch sensing device and a second tip connected to the reflective protecting electrode.

10. The touch panel as claimed in claim 9, wherein the first tip and the second tip are located on a same plane and adjacently and oppositely disposed.

11. The touch panel as claimed in claim 1, further comprising a protecting contacting pad located in the opening and connected to the reflective protecting electrode, so that the reflective protecting electrode is electrically connected to the conductive protrusion through the protecting contacting pad.

12. The touch panel as claimed in claim 1, further comprising at least one protecting connecting line located in the periphery region of the substrate and arranged in order with the signal connecting lines, wherein the at least one protecting connecting line and the reflective protecting electrode are electrically connected.

13. The touch panel as claimed in claim 1, wherein the touch sensing device comprises a capacitive touch sensing device.

14. The touch panel as claimed in claim 13, wherein the capacitive touch sensing device comprises a projected capacitive sensing device.

15. The touch panel as claimed in claim 1, wherein the reflective protecting electrode is located on the decoration pattern layer, the insulating layer covers the reflective protecting electrode, the signal connecting lines are located on the insulating layer, and the protection layer covers the signal connecting lines and the insulating layer.

16. The touch panel as claimed in claim 15, wherein the insulating layer further comprises a through hole, the through hole communicates with the opening of the protection layer so as to expose the reflective protecting electrode.

17. The touch panel as claimed in claim 1, wherein the signal connecting lines are located on the decoration pattern layer, the insulating layer covers the signal connecting lines, the reflective protecting electrode is located on the insulating layer, and the protection layer covers the reflective protecting electrode and the insulating layer.

18. The touch panel as claimed in claim 1, further comprising a plurality of auxiliary signal connecting lines located in a same layer with the reflective protecting electrode, wherein the auxiliary signal connecting lines and the touch sensing device are electrically connected.

19. The touch panel as claimed in claim 1, further comprising an auxiliary protecting electrode located in a same layer with the signal connecting lines, wherein the auxiliary protecting electrode and the reflective protecting electrode are electrically connected.

20. The touch panel as claimed in claim 1, wherein the conductive protrusion passes through the opening of the protection layer and is coupled to the reflective protecting electrode.

21. A touch display panel capable of assembling to a casing assembly, the casing assembly having at least one conductive protrusion, the touch display panel comprising:
a display panel having a light emitting side; and
a touch panel disposed on the light emitting side of the display panel and assembled to the display panel, wherein the touch panel comprises:
a substrate having a touch region and a periphery region, the periphery region surrounds the touch region;
a decoration pattern layer located in the periphery region of the substrate;
a touch sensing device located in the touch region of the substrate;
a reflective protecting electrode located in the periphery region of the substrate and overlapped with the decoration pattern layer;
an electrostatic discharge protecting device located on the substrate, wherein the electrostatic discharge protecting device is connected to the touch sensing device and the reflective protecting electrode so as to transmit a electrostatic charges of the touch sensing device to the reflective protecting electrode;
a plurality of signal connecting lines located in the periphery region of the substrate and overlapped with the decoration pattern layer, wherein the signal connecting lines are electrically connected to the touch sensing device;
an insulating layer disposed between the reflective protecting electrode and the signal connecting lines so that the reflective protecting electrode is electrically isolated from the signal connecting lines; and
a protection layer covering the touch sensing device, the electrostatic discharge protecting device, the signal connecting lines, the reflective protecting electrode and the decoration pattern layer, wherein the protection layer has at least one opening to expose a portion of the reflective protecting electrode such that the reflective protecting electrode is electrically connected to the conductive protrusion of the casing assembly through the opening.

22. The touch display panel as claimed in claim 21, wherein the display panel comprises a liquid crystal display (LCD) panel, an organic light emitting diode display panel, an electrophoresis display panel, a field emission display panel or a plasma display panel.

23. The touch display panel as claimed in claim 22, wherein the display panel comprises a finished product of display panel or a semi-finished product of display panel.

24. A touch display apparatus comprising:
a casing assembly having at least one conductive protrusion;
a display panel having a light emitting side; and
a touch panel disposed on the light emitting side of the display panel and assembled to the display panel, wherein the display panel is located between the touch panel and the casing assembly, wherein the touch panel comprises:
a substrate having a touch region and a periphery region, the periphery region surrounds the touch region;
a decoration pattern layer located in the periphery region of the substrate;
a touch sensing device located in the touch region of the substrate;
a reflective protecting electrode located in the periphery region of the substrate and overlapped with the decoration pattern layer;
an electrostatic discharge protecting device located on the substrate, wherein the electrostatic discharge protecting device is connected to the touch sensing device and the reflective protecting electrode so as to transmit a electrostatic charges of the touch sensing device to the reflective protecting electrode;
a plurality of signal connecting lines located in the periphery region of the substrate and overlapped with the decoration pattern layer, wherein the signal connecting lines are electrically connected to the touch sensing device;
an insulating layer disposed between the reflective protecting electrode and the signal connecting lines so that the reflective protecting electrode is electrically isolated from the signal connecting lines; and
a protection layer covering the touch sensing device, the electrostatic discharge protecting device, the signal connecting lines, the reflective protecting electrode and the decoration pattern layer, wherein the protection layer has at least one opening to expose a portion of the reflective protecting electrode such that the reflective protecting electrode is electrically connected to the conductive protrusion of the casing assembly through the opening.
